(19) United States
(12) Patent Application Publication
(10) Pub. No.: US 2021/0259070 A1
(43) Pub. Date: Aug. 19, 2021

(54) LIGHTING FIXTURE FOR DYNAMIC LIGHTING EFFECTS

(71) Applicant: IDEAL Industries Lighting LLC, Sycamore, IL (US)

(72) Inventor: Mark P. Boomgaarden, Cary, NC (US)

(21) Appl. No.: 16/794,626

(22) Filed: Feb. 19, 2020

(51) Int. Cl. H05B 45/10; H05B 45/20; H05B 47/105; F21V 3/06

(52) U.S. Cl. CPC H05B 45/10; F21V 3/0615; H05B 47/105; H05B 45/20

(57) ABSTRACT

A lighting fixture includes a housing, a light source, an optics array, and control circuitry. The housing includes an opening through which light is provided from the lighting fixture towards an area of interest. The light source is in the housing and includes a number of solid-state light sources. The optics array is also in the housing and includes a number of optics. Each optic in the optics array is configured to focus light from each one of the light sources into a number of beams of light such that each one of the beams of light is provided through the opening of the housing at a different angle. The control circuitry is configured to selectively illuminate the number of solid-state lighting sources such that a direction of light provided by the lighting fixture dynamically changes over time.

### FIELD OF THE DISCLOSURE

The present disclosure is related to lighting fixtures, and in particular to lighting fixtures for providing dynamic lighting effects such as dynamic lighting effects to simulate outdoor light sources in an indoor space.

### BACKGROUND

Recently, there has been a great deal of interest in dynamic lighting for indoor spaces. For example, it has recently been popularized to simulate outdoor environments within indoor spaces, as doing so has been found to improve productivity and wellbeing of individuals in the indoor space. While systems and methods have been proposed for simulating outdoor environments in indoor spaces, conventional lighting fixtures are not equipped to convincingly recreate the lighting conditions in an outdoor environment. Accordingly, there is a need for a lighting fixture with an improved ability to simulate the lighting conditions of an outdoor environment.

### SUMMARY

In one embodiment, a lighting fixture includes a housing, a light source, an optics array, and control circuitry. The housing includes an opening through which light is provided from the lighting fixture towards an area of interest. The light source is in the housing and includes a number of solid-state light sources. The optics array is also in the housing and includes a number of optics. Each optic in the optics array is configured to focus light from the light source into a number of beams of light such that each one of the beams of light is provided through the opening of the housing at a different angle. The control circuitry is configured to selectively illuminate the plurality of solid-state light sources such that a direction of light provided by the lighting fixture dynamically changes over time. By providing a lighting fixture in which the direction of light can be dynamically changed over time in a focused fashion using the beams of light, the lighting fixture can convincingly simulate lighting conditions in outdoor spaces.

In one embodiment, the control circuitry is configured to selectively illuminate the solid-state light sources such that the direction of light provided by the lighting fixture moves from east to west over time to emulate the natural movement of the sun.

In one embodiment, a beam angle of each one of the beams of light is between 5° and 60°.

In one embodiment, the optics array is configured to focus light from a first subset of the solid-state light sources into a first number of beams of light having a first beam angle and focus light from a second subset of the solid-state light sources into a second number of beams of light having a second beam angle that is different than the first beam angle. The control circuitry may separately control the intensity of light provided from the first subset of solid-state light sources and the second subset of solid-state light sources.

In one embodiment, each one of the optics is a collimating optic and the solid-state light sources are provided on a curved surface such that each one of the solid-state light sources is oriented in a different direction with respect to the opening of the housing. The curved surface may form an arc, a dome, or any other shape, including flat.

In one embodiment, the control circuitry is configured to adjust a correlated color temperature (CCT) of the solid-state light sources such that the CCT of the solid-state light sources dynamically changes over time. The control circuitry may also adjust an intensity of the solid-state light sources such that an intensity of the solid-state light sources dynamically changes over time.

In one embodiment, the lighting fixture includes a diffuser over the opening in the housing. The lighting fixture may include a faux window pane structure in front of the diffuser such that the lighting fixture appears to be a window.

In one embodiment, the lighting fixture includes one or more sensors. The control circuitry is configured to analyze sensor data from the one or more sensors to track one or more objects in the area of interest and selectively illuminate the solid-state light sources such that one or more of the beams of light selectively illuminate the one or more objects.

In one embodiment, the control circuitry is configured to selectively illuminate the solid-state light sources to identify a desired path for individuals traveling within the area of interest.

In one embodiment, the lighting fixture is configured to receive data indicative of one or more outdoor lighting conditions and selectively illuminate the solid-state light sources based on the one or more outdoor lighting conditions.

In one embodiment, the light source and the optics array are provided such that the beams of light can be provided between 5° and 60° with respect to the opening of the housing.

In one embodiment, each one of the optics in the optics array is configured to focus light from a single one of the solid-state light sources such that there is a 1:1 relationship between the optics and the solid-state light sources.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a diagram illustrating a lighting fixture according to one embodiment of the present disclosure.

FIG. 2 is a diagram illustrating a light engine for a lighting fixture according to one embodiment of the present disclosure.

FIG. 3 is a diagram illustrating a lighting fixture according to one embodiment of the present disclosure.

FIG. 4 is a diagram illustrating a lighting fixture according to one embodiment of the present disclosure.

FIGS. 5A and 5B are diagrams illustrating a lighting fixture according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

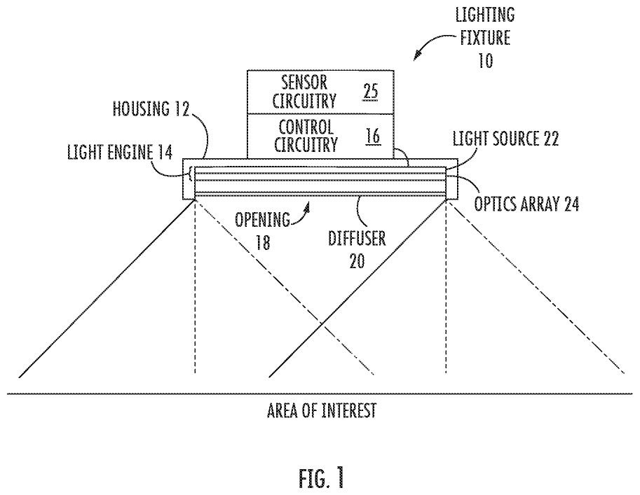

FIG. 1 is a diagram illustrating a lighting fixture 10 according to one embodiment of the present disclosure. The lighting fixture 10 includes a housing 12, a light engine 14 in the housing 12, and control circuitry 16, which may be inside the housing 12, coupled to the housing 12, or remote from the housing 12. The housing 12 includes an opening 18 through which light from the light engine 14 is provided towards an area of interest. The opening 18 may be covered by a diffuser 20 in some embodiments to diffuse light from the light engine 14 to a desired degree. The light engine 14 includes a light source 22 and an optics array 24. The light source 22 includes a number of individual solid-state light sources. The optics array 24 includes a number of optics, which are configured to focus light from the light source 22 into a number of beams of light such that each one of the number of beams of light exits the opening 18 at a different angle as discussed in detail below.

The control circuitry 16 is configured to selectively illuminate one or more of the solid-state light sources in the light source 22 such that the lighting fixture 10 provides one or more beams of light having a desired beam angle and wherein a direction of the one or more beams of light dynamically changes over time. For example, light provided from the lighting fixture 10 may shift from being provided towards a left portion of the area of interest (indicated by the parallel pair of solid lines), to being provided straight down towards a central portion of the area of interest (indicated by the pair of dashed lines), to being provided towards a right portion of the area of interest (indicated by the parallel pair of dashed and dotted lines). The control circuitry 16 may selectively illuminate the solid-state light sources in the light source 22 such that a transition between these states is seamless in order to simulate lighting conditions in an outdoor environment such as the sun moving across the sky throughout the day.

The solid-state light sources in the light source 22 may be light emitting diodes (LEDs). In some embodiments, a correlated color temperature, an intensity, or any other light characteristic of the solid-state light sources in the light source 22 may be adjustable by the control circuitry 16. The control circuitry 16 may control these light characteristics along with the direction of the light in order to simulate lighting conditions in an outdoor lighting environment.

In various embodiments, the control circuitry 16 may receive data indicating lighting conditions in an outdoor environment. This data may include weather data, cloud coverage data, or the like, and may describe real time lighting conditions in a particular outdoor environment, such as the outdoor environment in which a building including the lighting fixture 10 is located. The control circuitry 16 may use the data indicating the lighting conditions in the outdoor environment to adjust the directionality of light provided from the lighting fixture 10 as well as the CCT, intensity, or any other light characteristic to simulate the outdoor environment. For example, the control circuitry 16 may dynamically change a direction of one or more beams of light provided from the light source 22 to synchronize with the movement of the sun across the sky.

The dynamic lighting provided by the lighting fixture 10 may be provided in synchronization with the light provided by one or more other lighting fixtures in order to provide circadian cues to individuals within an indoor space. Doing so may improve the productivity and wellbeing of the individuals. In some embodiments, the dynamic lighting provided by the lighting fixture 10 may be used to provide light therapy for individuals within the space, for example, to mitigate conditions such as seasonal affective disorder.

While not shown, the control circuitry 16 may receive power from a power source such as an alternating current (AC) power source or a direct current (DC) power source for powering the lighting fixture 10. The control circuitry 16 may modulate, condition, or selectively apply power from the power source to the light source 22 in order to control the light emitted therefrom. In other embodiments, the lighting fixture 10 may include driver circuitry (not shown) that is separate from the control circuitry 16. In such an embodiment, the control circuitry 16 may provide control signals to the driver circuitry for controlling the light emitted from the light source 22.

In various embodiments, the lighting fixture 10 may further include sensor circuitry 25 coupled to the control circuitry 16. The sensor circuitry 25 may include one or more sensors, each of which provides sensor data to the control circuitry 16. For example, the sensor circuitry 25 may include a motion sensor, an occupancy sensor, an image sensor, a microphone, a temperature sensor, or any other type of sensor. The control circuitry 16 may use sensor data from the sensor circuitry 25 to determine one or more conditions of the environment surrounding the lighting fixture 10 and control one or more characteristics of the light from the light source 22 in response thereto. For example, the control circuitry 16 may use sensor data from the sensor circuitry 25 to determine an occupancy condition of the environment surrounding the lighting fixture 10 and control one or more characteristics of the light from the light source 22 in response thereto. Since, as discussed herein, the lighting fixture 10 is configured to provide focused beams of light having a desired direction and beam angle, the control circuitry 16 may use sensor data from the sensor circuitry 25 to track one or more objects in the area of interest and control one or more solid-state light sources in the light source 22 to selectively illuminate the one or more objects such that they stand out from the surrounding environment. In one embodiment, the control circuitry 16 may control one or more solid-state light sources in the light source 22 to illuminate a desired path for travel in the area of interest. Such a feature may be useful for indicating directions to an individual in an indoor space, in emergency conditions, or the like. In general, the control circuitry 16 may use sensor data from the sensor circuitry 25 in order to selectively illuminate any portion of the area of interest or any objects within the area of interest as desired. In addition to the selective and directional light that can be provided from the lighting fixture 10, when a certain number of solid-state light sources in the light source 22 are illuminated light suitable for general illumination can also be provided from the lighting fixture 10 as desired.

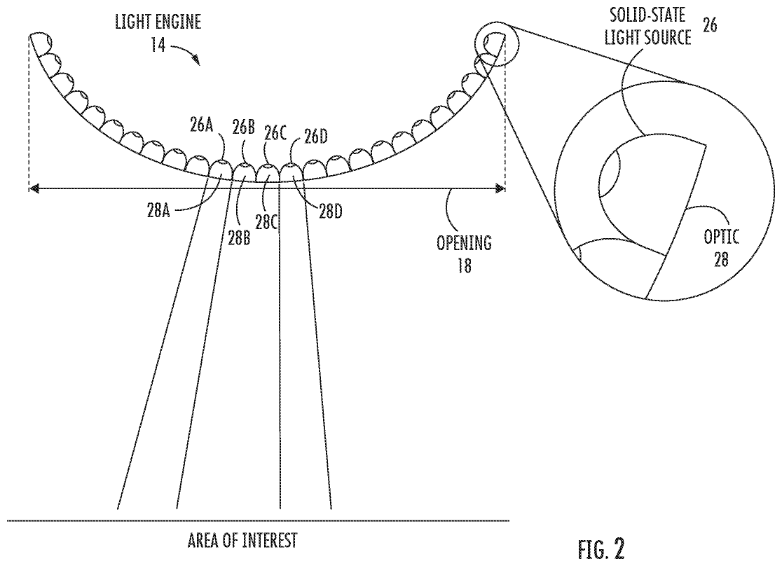

FIG. 2 illustrates details of the light engine 14 according to one embodiment of the present disclosure. As discussed above and shown in FIG. 2, the light engine 14 includes the light source 22 made up of a number of solid-state light sources 26 and the optics array 24 made up of a number of optics 28. The solid-state light sources 26 are arranged such that each one of the solid-state light sources 26 has a different orientation with respect to the opening 18 of the housing 12, for example, by providing them on a curved surface. Each solid-state light source 26 may be associated with an optic 28 to focus the light provided therefrom into a beam. Accordingly, each one of the solid-state light sources 26 provides a beam of light that exits the opening 18 of the housing 12 at a different angle. Beams of light from adjacent ones of the solid-state light sources 26 may be adjacent or slightly overlapping as they reach the area of interest such that beams of light from adjacent or otherwise related ones of the solid-state light sources 26 can be combined to form a beam having a desired beam angle.

The beam angle of the beam of light provided from each solid-state light source 26 and optic 28 may be between 5° and 60°. By combining beams of light from multiple ones of the solid-state light sources 26, nearly any beam angle may be achieved between 5° and 180° (providing total coverage including the light that would normally be provided from a lighting fixture for general illumination). For example, a beam angle of a first solid-state light source 26A and a first optic 28A may be 15°, a beam angle of a second solid-state light source 26B and a second optic 28B may be 15°, a beam angle of a third solid-state light source 26C and a third optic 28C may be 15°, and a beam angle of a fourth solid-state light source 26D and a fourth optic 28D may be 15°. If any one of the first solid-state light source 26A through the fourth solid-state light source 26D are illuminated, a narrow beam of light with a beam angle of 15° is provided from the light engine 14. Depending on which one of the first solid-state light source 26A through the fourth solid-state light source 26D is illuminated, a direction of the beam of light provided from the light engine 14 will change due to the different orientation of the solid-state light sources 26 with respect to the opening 18. If the second solid-state light source 26B and the third solid-state light source 26C are illuminated, the combined light therefrom provides a beam angle of 30° from the light engine 14. If all of the first solid-state light source 26A through the fourth solid-state light source 26D are illuminated, the combined light therefrom provides a beam angle of 60° from the light engine 14. The control circuitry 16 thus may selectively illuminate different ones of the solid-state light sources 26 to achieve a desired beam angle and direction of the beam.

In some embodiments, the optics 28 focus the light from different ones of the solid-state light sources 26 to have different beam angles. For example, the optics 28 may be configured to focus the light from a first subset of the solid-state light sources 26 to provide a first beam angle and focus the light from a second subset of the solid-state light sources 26 to provide a second beam angle that is different from the first beam angle. Such an approach may be useful for simulating a more diverse set of outdoor lighting conditions. For example, in one embodiment the first solid-state light source 26A and the fourth solid-state light source 26D may have a beam angle of 15° while the second solid-state light source 26B and the third solid-state light source 26C may have a beam angle of 25°. The control circuitry 16 may selectively illuminate these solid-state light sources 26 to create a desired effect. For example, the first solid-state light source 26A and/or the fourth solid-state light source 26D may be illuminated to simulate the intense light provided by the sun on a clear day, while the second solid-state light source 26B and/or the third solid-state light source 26C may be illuminated to simulate the diffuse light provided by the sun on a cloudy day. In general, the beam angles and diffusion of any subset of the solid-state light sources 26 may be varied as desired, for example, in a repeating pattern from left to right in the light engine 14 as shown, in order to provide various beams of light that can be activated by illuminating a corresponding one of the solid-state light sources 26.

While the solid-state light sources 26 and the optics 28 are shown in a curved configuration such that each one has a different orientation with respect to the opening 18 in the housing 12 in order to achieve directionality with respect to the beams of light provided therefrom, the present disclosure is not limited to such a configuration for the light engine 14. In some embodiments, the solid-state light sources 26 may be provided on a flat plane and the optics 28 may be configured to focus the light from the solid-state light sources 26 to provide a number of beams of light that exit the opening 18 at different angles such that the lighting fixture 10 can provide focused beams of light with a desired degree of directionality. Those skilled in the art will recognize that there may be a number of different ways to focus the light from the solid-state light sources 26 such that beams of light that exit the opening 18 at different angles exist, all of which are contemplated herein. Further, while the light engine 14 is illustrated as having a single row of solid-state light sources 26 and optics 28, the light engine 14 may extend into and out of the page to include multiple rows of solid-state light sources 26 and optics 28. In some embodiments, the solid-state light sources 26 and optics 28 may form a dome or any other suitable shape for increasing the coverage of directional light that can be provided therefrom.

While FIG. 2 illustrates the solid-state light sources 26 having a 1:1 relationship with the optics 28 such that each optic 28 focuses light from a single solid-state light source 26 to provide a beam of light as discussed above, there may be any number of optics 28 used to focus the light from a solid-state light source 26 to achieve the same result or there may be any number of solid-state light sources 26 for which a single optic 28 focuses the light therefrom to achieve the same result.

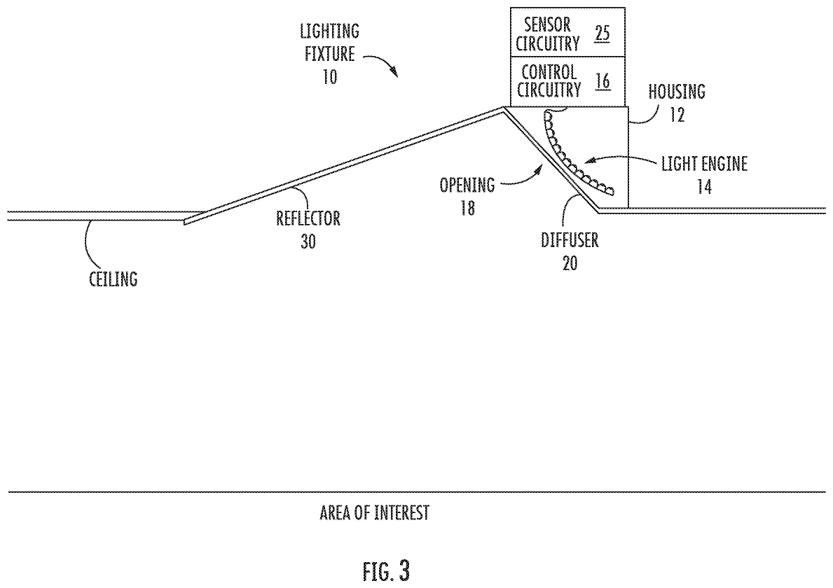

FIG. 3 is a diagram illustrating the lighting fixture 10 according to an additional embodiment of the present disclosure. The lighting fixture 10 shown in FIG. 3 is substantially similar to that shown in FIG. 1, but is sized and shaped to accommodate the light engine 14 when it is curved into an arc and the lighting fixture 10 is provided in a ceiling. The housing 12 accommodates the curved light engine 14 such that the diffuser 20 is between the light engine 14 and the area of interest. The lighting fixture 10 may further include a reflector 30 configured to bounce light emitted from the light engine 14 towards the area of interest.

As discussed above, each solid-state light source 26, along with an associated optic 28, provides a beam of light having a desired beam angle. Because the solid-state light sources 26 in the light engine 14 each have a different orientation with respect to the opening 18 of the housing 12, each solid-state light source 26 provides a beam of light that exits the opening 18 at a different angle. By controlling the orientation of the solid-state light sources 26 and the optics 28 in the light engine 14, a desired coverage area of the area of interest may be achieved such that a beam of light can be provided anywhere within the desired coverage area, and beams of light can be combined to illuminate any portion of the desired coverage area.

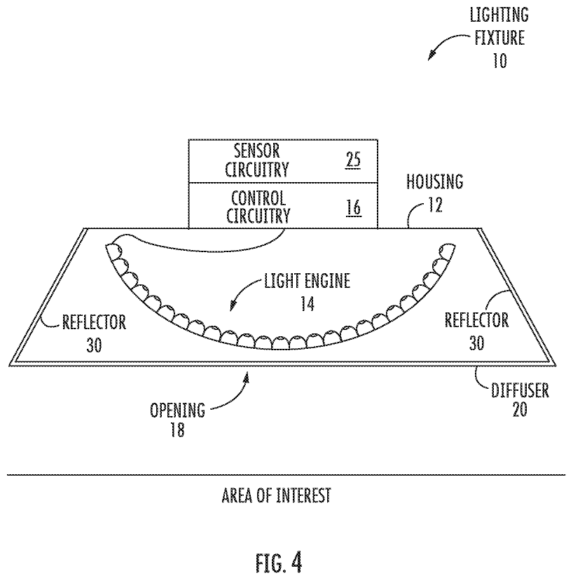

FIG. 4 is a diagram illustrating the lighting fixture 10 according to an additional embodiment of the present disclosure. The lighting fixture 10 shown in FIG. 4 is substantially similar to that shown in FIGS. 1 and 3, but is sized and shaped to accommodate the light engine 14 when it is curved into an arc forming half of a circle and/or a dome and the lighting fixture 10 is a troffer or hanging fixture. The lighting fixture 10 may include two reflectors 30 on each side of an interior of the housing 12 to bounce light emitted from the light engine 14 towards the area of interest.

As discussed above, each solid-state light source 26, along with an associated optic 28, provides a beam of light having a desired beam angle. Because the solid-state light sources 26 in the light engine 14 each have a different orientation with respect to the opening 18 of the housing, each solid-state light source 26 provides a beam of light that exits the opening 18 at a different angle. By controlling the orientation of the solid-state light sources 26 and the optics 28 in the light engine 14, a desired coverage area of the area of interest may be achieved such that a beam of light can be provided anywhere within the desired coverage area, and beams of light can be combined to illuminate any portion of the desired coverage area.

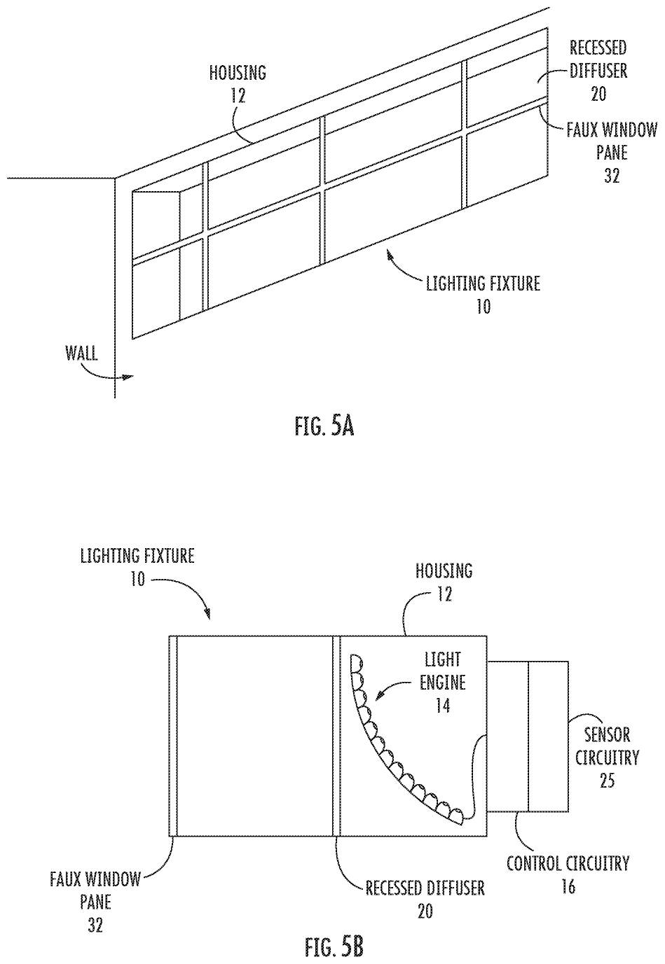

FIGS. 5A and 5B illustrate the lighting fixture 10 according to an additional embodiment of the present disclosure. While the lighting fixture 10 illustrated in FIGS. 1, 3, and 4 is configured to be provided in or otherwise suspended from a ceiling, the lighting fixture 10 in FIGS. 5A and 5B is configured to be provided in a wall that is perpendicular to a floor and simulate a window. Such a lighting fixture 10 may be especially useful in indoor spaces in which windows are not available. FIG. 5A shows a perspective view of the lighting fixture 10, while FIG. 5B shows a cross-sectional view of the lighting fixture 10. As shown, the lighting fixture 10 is recessed into a wall. The housing 12 supports the light engine 14 and the diffuser 20, which is recessed with respect to the wall. A faux window pane 32, which is configured to look like a conventional window, is provided over the diffuser 20. Notably, the exemplary lighting fixture 10 illustrated in FIGS. 5A and 5B is only one way in which to accomplish the objective of making the lighting fixture 10 simulate a conventional window. Because the lighting fixture 10 is capable of providing beams of light that are directional as discussed above, the light provided form the lighting fixture 10 can simulate the directional sunlight that normally enters through a conventional window, creating the same light patterns and shadows that an individual would normally expect therefrom. Accordingly, the lighting fixture 10 may be used to make indoor spaces in which windows are not available significantly more enjoyable for the individuals therein, in some cases increasing productivity and wellbeing.

Those skilled in the art will recognize improvements and modifications to the preferred embodiments of the present disclosure. All such improvements and modifications are considered within the scope of the concepts disclosed herein and the claims that follow.

What is claimed is:

1. A lighting fixture comprising:
a housing comprising an opening through which light is provided towards an area of interest;
a light source in the housing and comprising a plurality of solid-state light sources;
an optics array in the housing and comprising a plurality of optics configured to focus the light from the light source into a plurality of beams of light such that each one of the plurality of beams of light is provided through the opening of the housing at a different angle; and
control circuitry configured to selectively illuminate the plurality of solid-state light sources such that a direction of light provided by the lighting fixture dynamically changes over time.

2. The lighting fixture of claim 1 wherein the control circuitry is configured to selectively illuminate the plurality of solid-state light sources such that the direction of light provided by the lighting fixture moves from east to west over time to emulate the natural movement of the sun.

3. The lighting fixture of claim 1 wherein a beam angle of each one of the plurality of beams of light is between 5° and 60°.

4. The lighting fixture of claim 1 wherein the optics array is configured to:
focus light from a first subset of the plurality of solid-state light sources into a first plurality of beams of light having a first beam angle: and
focus light from a second subset of the plurality of solid-state light sources into a second plurality of light beams having a second beam angle that is different than the first beam angle.

5. The lighting fixture of claim 4 wherein the control circuitry is further configured to separately control an intensity of the light provided from the first subset of the plurality of solid-state light sources and an intensity of the light provided by the second subset of the plurality of solid-state light sources.

6. The lighting fixture of claim 1 wherein:
each one of the plurality of optics is a collimating optic; and
each one of the plurality of solid-state light sources is provided on a curved surface such that each one of the plurality of solid-state light sources has a different orientation with respect to the opening of the housing.

7. The lighting fixture of claim 6 wherein the curved surface provides an arc.

8. The lighting fixture of claim 6 wherein the curved surface provides a dome.

9. The lighting fixture of claim 1 wherein the control circuitry is further configured to adjust a correlated color temperature (CCT) of the plurality of solid-state light sources such that a CCT of the light provided by the lighting fixture dynamically changes over time.

10. The lighting fixture of claim 9 wherein the control circuitry is further configured to adjust an intensity of the plurality of solid-state light sources such that the intensity of the light provided by the lighting fixture dynamically changes over time.

11. The lighting fixture of claim 9 wherein the control circuitry is further configured to adjust an intensity of the plurality of solid-state light sources such that the intensity of the light provided by the lighting fixture dynamically changes over time.

12. The lighting fixture of claim 1 further comprising a diffuser over the opening in the housing.

13. The lighting fixture of claim 12 wherein the diffuser comprises a faux window pane structure in front of the diffuser such that the lighting fixture appears to be a window.

14. The lighting fixture of claim 13 wherein the lighting fixture is configured to be installed in a wall perpendicular to a floor in a space.

15. The lighting fixture of claim 1 wherein:
the lighting fixture further comprises one or more sensors; and
the control circuitry is configured to analyze sensor data from the one or more sensors to track one or more objects in the area of interest and selectively illuminate the plurality of solid-state light sources such that one or more of the plurality of beams of light selectively illuminate the one or more objects.

16. The lighting fixture of claim 1 wherein the control circuitry is further configured to selectively illuminate the plurality of solid-state light sources to identify a desired path for individuals traveling within the area of interest.

17. The lighting fixture of claim 1 wherein the control circuitry is further configured to selectively illuminate the plurality of solid-state light sources to provide the light suitable for general illumination of the area of interest.

18. The lighting fixture of claim 1 wherein the control circuitry is further configured to:
receive data indicative of one or more outdoor lighting conditions; and
selectively illuminate the plurality of solid-state light sources based on the one or more outdoor lighting conditions.

19. The lighting fixture of claim 1 wherein the light source and the optics array are provided such that the plurality of beams of light can be provided between 5° and 180° with respect to the opening of the housing.

20. The lighting fixture of claim 1 wherein each one of the plurality of optics is configured to focus the light from a single one of the plurality of solid-state light sources such that there is a 1:1 relationship between the plurality of optics and the plurality of solid-state light sources.
